(19) United States
(12) Patent Application Publication
(10) Pub. No.: US 2005/0175423 A1
(43) Pub. Date: Aug. 11, 2005

(54) Drilling device for left-handed and right-handed users

(76) Inventors: George Ku, Taiping City (TW); Eric Lo, Dali City (TW); Ruey Zon Chen, Dali City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/772,461

(22) Filed: Feb. 6, 2004

(51) Int. Cl. B23B 47/18; B23B 47/00

(52) U.S. Cl. 408/136

(57) ABSTRACT

A drilling device for the left-handed users and the right-handed users, includes a base, a housing, a drilling chuck, a feeding horizontal shaft, a roll-shaped spring and two control units, wherein the housing is disposed above the base, the drilling chuck is disposed on the bottom surface of the housing, the feeding horizontal shaft is penetrated through the housing and has two ends bulging out the surface of the housing, the roll-shaped spring is mounted on one end of the feeding horizontal shaft, and the two control units have two hubs which are assembled disposed at the two ends of the feeding horizontal shaft and simultaneously only have ones of the right-handed handles and the left-handed handles which can be lockable jointed at the one of the two hubs, such that when a user operates the drilling device, the user can keep ones or all of the right-handed handles and the left-handed handles for operating the drilling device according to personal habitual behavior. Thus, the drilling device can fully meet the requirement for usage of different users.

### FIELD OF THE INVENTION

The present invention relates to a drilling device, and more particularly to a vertical drilling device which provides a control mechanism for left-handed users or right-handed users so as to meet the requirement for different users during operation.

### BACKGROUND OF THE INVENTION

Referring to FIG. 7, it is necessary to utilize a drilling machine 70 for drilling a hole on the surface of steel material or wood material. The drilling machine includes a base 71, a housing 72, a drilling chuck 73, a control unit 74 and a drilling worktable 75, wherein the housing 72 is disposed on the base 71, the interior of the housing 72 is provided with a transmission mechanism (not shown), and the top surface of the housing 72 is provided with a transmission box 76. A motor 77 is installed on the back of the housing 72 for driving the belt pulleys and rollers of the transmission box 76, thereby driving the transmission mechanism in the housing 72 to be operated so as to drive a drilling chuck 73 which is disposed on the bottom surface of the housing 72. Furthermore, the control unit 74 is disposed on one side of the housing 72 and connected to the drilling chuck 73. When a user operates the control unit 74, the control unit 74 drives the drilling chuck 73 to move downward to the drilling worktable 75 which is disposed on the base 71. Simultaneously, it achieves an object that the drill bit (not shown), mounted on the drilling chuck 73 is rotated for drilling a hole in the workpiece which is placed on the drilling worktable 75.

The above-mentioned drilling machine 70 has good effect on drilling, but the drilling machine 70 only provides one set of control unit 74. Although the right-handed user can conveniently operate the drilling machine 70, the left-handed user cannot smoothly operate the drilling machine 70 because of different habitual behavior.

### SUMMARY OF THE INVENTION

Accordingly, most drilling machines in the prior art are designed for right-handed users, not for left-handed users. Therefore, the present invention provides a drilling device, which is operated by a right hand and a left hand, so as to achieve the object of convenient operation.

According to the foregoing disclosed object and effect, the present invention provides a drilling device for both left-handed and right-handed users, wherein the housing is provided with a feeding horizontal shaft, the feeding horizontal shaft is jointed to a mechanism which controls the drilling chuck to move upward or downward, two ends of the feeding horizontal shaft are respectively provided with one control unit, such that the user uses his right hand or left hand to operate the drilling device according to personal habitual behavior. Thus, the drilling device has the effect on convenient operation and can really meet the requirement of actual operation.

The above-mentioned two sets of the control units are provided with handles which can be assembled and disassembled. During normal operation, only one set of the control units is requested to be provided with the handles. Of course, the user can choose that two sets of the control units are both requested to be provided with the handles during normal operation.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective schematic view of a drilling device according to the present invention.

FIG. 2 is a perspective partial schematic view of a drilling device according to the present invention.

FIG. 3 is a perspective exploded partial schematic view of a drilling device according to the present invention.

FIG. 4 is a partial sectional schematic view of a drilling device according to the present invention, showing an organization of a control unit.

FIG. 4A is a perspective partial schematic view of a drilling device according to the present invention, showing an organization of a control unit.

FIG. 5 is a front elevational partial schematic view of a drilling device according to the present invention, showing an embodiment of a right hand operation.

FIG. 6 is a front elevational partial schematic view of a drilling device according to the present invention, showing an embodiment of a left hand operation.

FIG. 7 is a perspective schematic view of a drilling machine in the prior art.

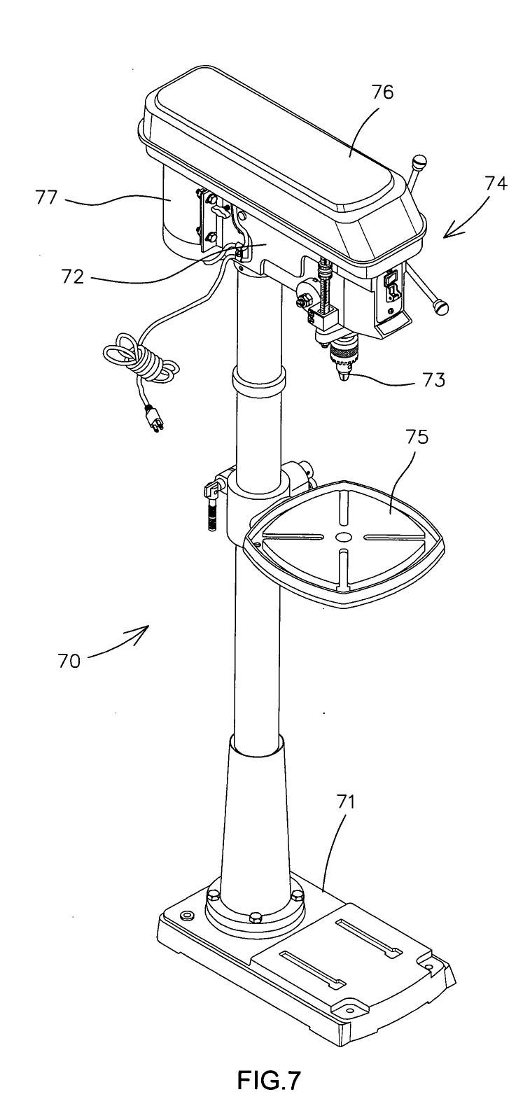

### DESCRIPTION OF THE PREFERRED EMBODIMENTS

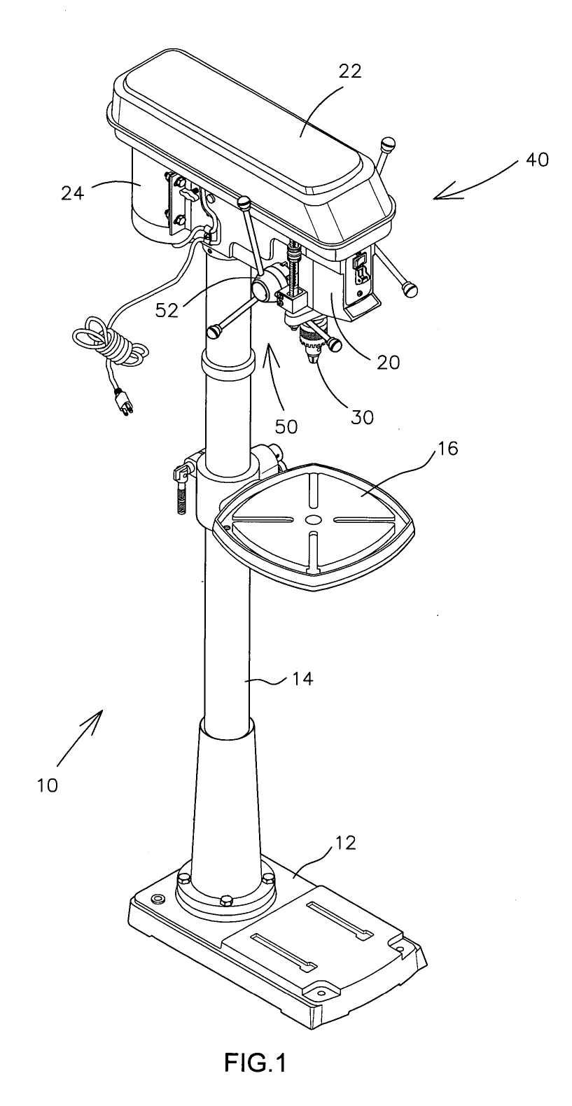

Referring to FIG. 1, the drilling device according to the present invention includes a base 12 having a column (assembly) 14 provided with a drilling worktable 16. The position of the drilling worktable 16 which is disposed at the column 14 can be adjustable.

A housing 20 is disposed above the base 12, a transmission mechanism (not shown) is disposed in the interior of the housing 20, and a transmission box 22 is disposed on the top of the housing 20. The pulley assembly which is constituted by plurality of belt pulleys is mounted in the transmission box 22, and is connected to the transmission mechanism in the housing 20, such that the motor 24 which is installed on the back of the housing 20 rotates to drive the belt pulleys in the transmission box 22 and then drive the transmission mechanism to be operated. The pulley assembly which is disposed in the transmission box 22 is used for adjusting spindle speed.

Furthermore, a drilling chuck 30 is disposed on the bottom surface of the housing 20 and used for clamping a drill bit (not shown). The drilling chuck 30 is driven by the transmission mechanism in the housing 20 and then can be rotated.

Furthermore, two control units 40, 50 are respectively disposed on the two sides of the housing 20, and the control units 40, 50 respectively drive the drilling chuck 30 to move downward when a user operates the control units 40, 50.

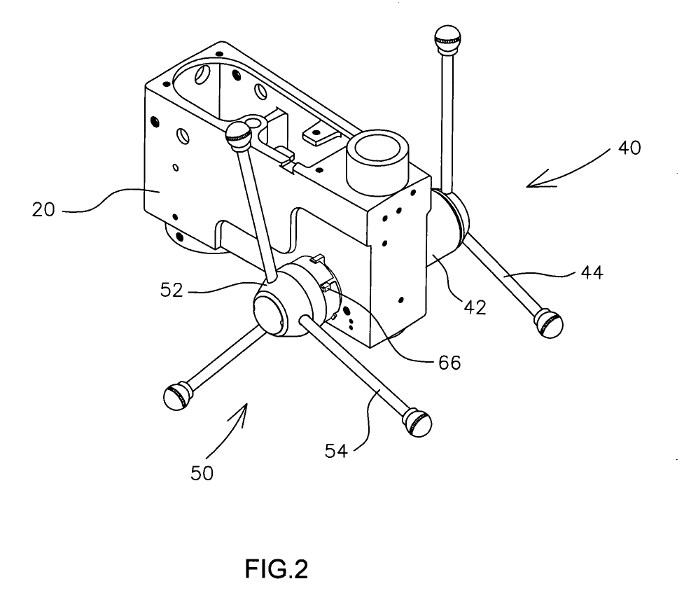

Referring to FIGS. 2, 3 and 4, the control units 40, 50 which are disposed on the two sides of the housing 20 respectively include a hub 42 and a hub 52, and the control units 40, 50 are respectively provided with plurality of handles 44, 54. Furthermore, a feeding horizontal shaft 60 and a roll-shaped spring 66 are disposed between the two control units 40, 50.

As described more detailed, the feeding horizontal shaft 60 is transversely penetrated through the housing 20, and two ends of the feeding horizontal shaft 60 are bulged out the surface of the housing 20. The toothed portion 62 which is mounted on the feeding horizontal shaft 60 is positioned in the housing 20 and can drive the drilling chuck 30. In other words, when the feeding horizontal shaft 60 is rotated, the drilling chuck 30 can be driven by the toothed portion 62 to move downward or upward.

The roll-shaped spring 66 is put around the one end of the feeding horizontal shaft 60 bulged out the surface of the housing 20, is close to the side surface of the housing 20, and one end of the roll-shaped spring 66 can be jointed to the feeding horizontal shaft 60. Thus, when the feeding horizontal shaft 60 is rotated, the roll-shaped spring 66 can be deformed by the rotation of the feeding horizontal shaft 60 and then the roll-shaped spring 66 provides the feeding horizontal shaft 60 with necessary recoverable force of the rotation.

It is apparent to one of ordinary skill in the art that the hub 42 of the control unit 40 and the hub 52 of the control unit 50 are assembled disposed at the two ends of the feeding horizontal shaft 60 and simultaneously only ones of the handles 44 and the handles 54 can be lockable jointed at the periphery of the hubs 42, 52. For example, when a right-handed user is changed to be a left-handed user, the handles can be taken away from the hub 42 and then lockable jointed at the periphery of the hub 52. Thus, the drilling device typically has ones of the handles 44 and the handles 54 which are convenient for the right-handed or left-handed user.

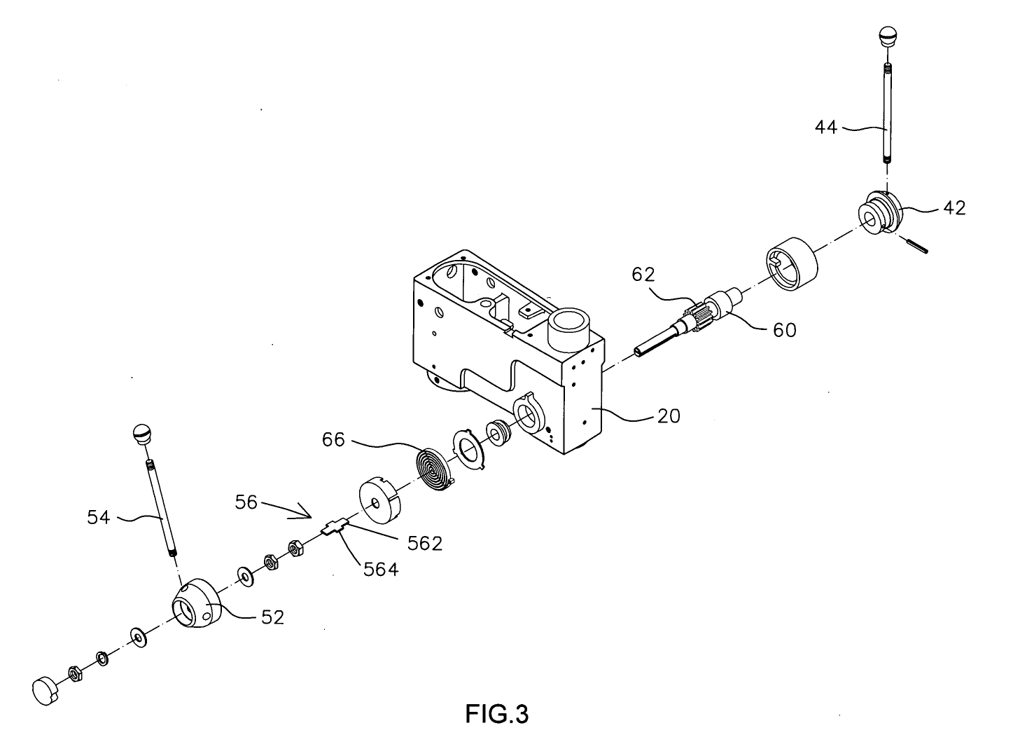

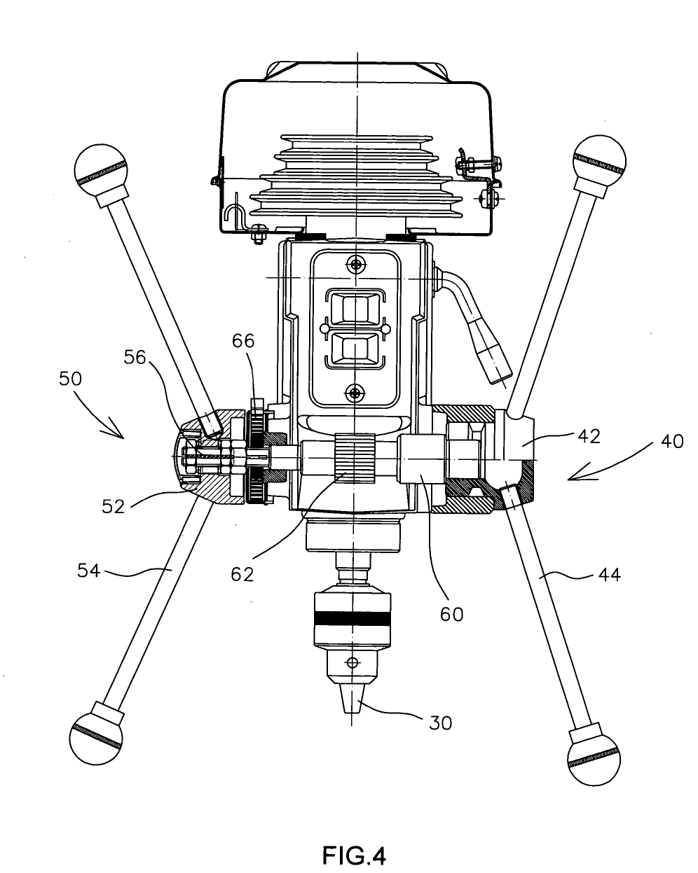

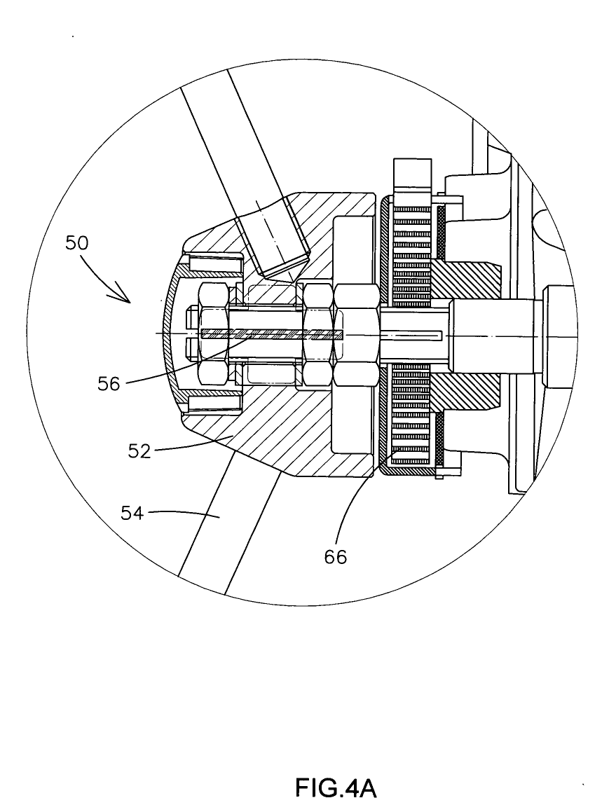

Referring to FIGS. 3 and 4A, when the control unit 50 is disposed at the end of the feeding horizontal shaft 60, a linking element 56 is mounted between the feeding horizontal shaft 60 and the hub 52. The linking element 56 has a first portion 562 which is inserted into a groove 63 located in the feeding horizontal shaft 60 and a second portion 564 which is jointed to the hub 52, such that the feeding horizontal shaft 60 and the hub 52 can be simultaneously rotated to achieve the object of force transmission.

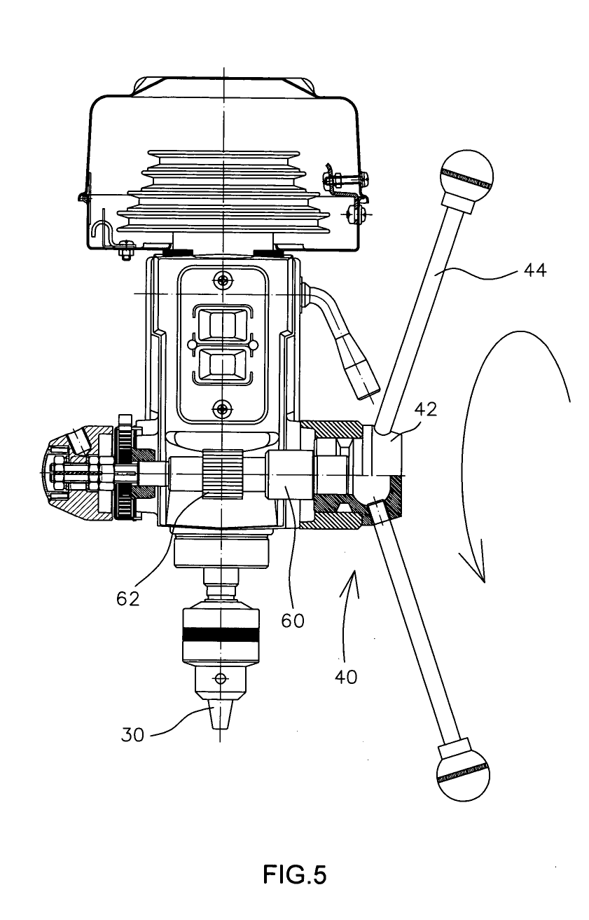

Referring to FIG. 5, if the user gets used to the right hand, then the plurality of handles 44 of the hub 42 of the control unit 40 located at right side can be kept and the plurality of handles (not shown) of the hub 52 of the control unit 50 located at the other side can be taken away.

When the user operates the handles 44, the feeding horizontal shaft 60 and the hub 42 are simultaneously rotated. At the same time, the toothed portion 62 drives the drilling chuck 30 to move downward, and the roll-shaped spring 66 can be also deformed by the feeding horizontal shaft 60. Thus, the user can smoothly achieve the object of drilling. When the user reversely operates the control unit 40 to drive the drill bit to move out a work piece, the user can cooperate with recoverable force caused by the roll-shaped spring 66 and save more effort to operate the control unit 40 to be recovered a original position.

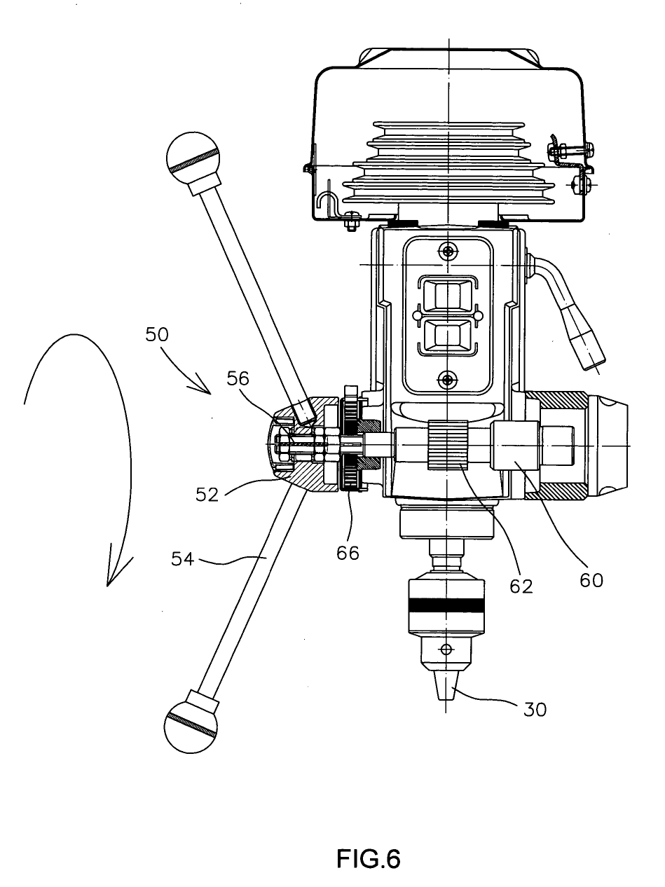

Referring to FIG. 6, if the user gets used to the left hand, then the plurality of handles 54 of the hub 52 of the control unit 50 located at left side can be kept and the plurality of handles (not shown) of the hub 42 of the control unit 40 located at the other side can be taken away. When the user operates the handles 54, the feeding horizontal shaft 60 and the hub 52 are simultaneously rotated. At the same time, the toothed portion 62 drives the drilling chuck 30 to move downward, and the roll-shaped spring 66 can be also deformed by the feeding horizontal shaft 60. Thus, the user can smoothly achieve the object of drilling. When the user reversely operates the control unit 50 to drive the drill bit to move out a work piece, the user can cooperate with recoverable force caused by the roll-shaped spring 66 and save more effort to operate the control unit 50 to be recovered a original position.

As described above, the present invention provides the organization of the feeding horizontal shaft 60 and the roll-shaped spring 66 and the disassembled and assembled aspect of the plurality of handles 44, 54 of the hubs 42, 52 of the control units 40, 50, such that different users operate the drilling device according to personal habitual behavior. Thus, the drilling device has the effect on convenient operation and can really meet the requirement of actual operation.

While the foregoing description and drawings represent the preferred embodiments of the present invention, it will be understood that various additions, modifications and substitutions may be made therein without departing from the spirit and scope of the principles of the present invention as defined in the accompanying claims. One skilled in the art will appreciate that the invention may be used with many modifications of form, structure arrangement, proportions, materials, elements, and components and otherwise, used in the practice of the invention, which are particularly adapted to specific environments and operating requirements without departing from the principles of the present invention. The presently disclosed embodiments are therefore to be considered in all respects as illustrative and not restrictive, the scope of the invention being indicated by the appended claims and their legal equivalents, and not limited to be the foregoing description.

1. A drilling device for the left-handed users and the right-handed users, comprising:
a base;
a housing disposed above the base and provided with a transmission mechanism disposed in the interior thereof;
a drilling chuck disposed on the bottom surface of the housing for clamping a drill bit, and driven by the transmission mechanism in the housing and then rotated;
a feeding horizontal shaft penetrated through the housing, having two ends bulging out the surface of the housing, perpendicular corresponding to the drilling chuck, and driving the drilling chuck to move downward;
a roll-shaped spring mounted on the feeding horizontal shaft, corresponding to one side of a surface of the housing, and deformed by operating a drilling motion and thereby providing a recoverable force; and
two control units disposed at two ends of the feeding horizontal shaft and respectively have a hub, wherein one of the control units has plurality of handles mounted on one of the hubs according to operating requirement so as to conveniently operate the drilling device.

2. The drilling device for left-handed users and right-handed users according to claim 1, wherein the feeding horizontal shaft has toothed portion for driving the drilling chuck to move downward.

3. The drilling device for left-handed users and right-handed users according to claim 1, wherein the feeding horizontal shaft is provided with a linking element jointed to one of the hubs of the control units, such that the feeding horizontal shaft and the hubs of the two control units are simultaneously rotated.
